(19) United States
(12) Patent Application Publication
(10) Pub. No.: US 2026/0047711 A1
(43) Pub. Date: Feb. 19, 2026

(54) Rug Corner Pet-Chewing Prevention Device

(71) Applicants: Claudia Klug, Harriman, TN (US); Harry Klug, Harriman, TN (US)

(72) Inventors: Claudia Klug, Harriman, TN (US); Harry Klug, Harriman, TN (US)

(21) Appl. No.: 18/932,859

(22) Filed: Oct. 31, 2024

Related U.S. Application Data
(60) Provisional application No. 63/682,387, filed on Aug. 13, 2024.

(51) Int. Cl. A47G 27/02; A01K 13/00

(52) U.S. Cl. CPC A47G 27/0243; A01K 13/00

(57) ABSTRACT

A rug corner pet-chewing prevention device is provided. The device comprises a durable, flexible body made from materials like thermoplastic elastomer or silicone-based rubber, providing resilience and non-slip properties. The body is shaped to fit around various corners, such as rugs or furniture legs, enhancing its versatility. It may include pet deterrents like bitter flavors or scent-based repellents, integrated through a microencapsulation process for lasting effectiveness. The body also comprises textured interior surfaces and fasteners to ensure stability, while the bottom surface is equipped with non-slip features and optional fasteners like suction cups or adhesives to prevent movement on different floor types. The device is installed by enclosing the corner within the body and securing it to the floor with the fasteners.

### CROSS-REFERENCE TO RELATED APPLICATION

The present application claims priority to, and the benefit of, U.S. Provisional Application No. 63/682,387, which was filed on Aug. 13, 2024, and is incorporated herein by reference in its entirety.

### FIELD OF THE INVENTION

The present invention relates generally to the field of rug protector devices. More specifically, the present invention relates to a rug corner pet-chewing prevention device that prevents a pet from chewing on a corner of a rug. Accordingly, the present disclosure makes specific reference thereto. Nonetheless, it is to be appreciated that aspects of the present invention are also equally applicable to other like applications, devices, and methods of manufacture.

### BACKGROUND

Cats, dogs, rabbits, and other household pets frequently display behaviors such as chewing on furniture, which can result in considerable damage to the home over time. This destructive habit can target various items, including rugs and carpet. Without reliable solutions to protect these household items, homeowners may find themselves in an ongoing cycle of having to repair or completely replace their rugs or carpet due to it being torn or chewed on. The financial burden of replacing expensive rugs or carpet can add up quickly, especially when these items hold sentimental value or are costly investments. Beyond the frustration of seeing one's home decor deteriorate, there is also the inconvenience of needing to make frequent repairs to restore a home's aesthetic.

However, the issue goes beyond the destruction of property. When pets chew on rugs or carpet, they run the risk of accidentally swallowing harmful foreign objects, such as fabric threads. Ingesting these items can pose serious health risks, potentially leading to digestive blockages, internal injuries, or poisoning, depending on the material. In severe cases, emergency veterinary care may be required, including diagnostic tests such as X-rays, ultrasounds, and surgery to remove the ingested objects. Such procedures can be not only distressing for the pet but also result in unexpectedly high medical bills for the owner.

Given the potential damage to both furniture and the health of pets, finding effective methods to prevent these chewing behaviors is essential. Protecting furniture from damage can help homeowners save money and preserve the appearance of their living spaces, while also ensuring that pets remain safe from the risks associated with swallowing foreign materials. With proper preventative measures in place, pet owners can create a safer and more harmonious environment for both themselves and their pets.

Therefore, there exists a long-felt need in the art for a device for preventing a pet from chewing on a rug or carpet. There also exists a long-felt need in the art for a rug corner pet-chewing prevention device that can prevent a pet from chewing on a rug corner. More specifically, there exists a long-felt need in the art for a rug corner pet-chewing prevention device that can prevent a pet from chewing on a rug corner by covering a rug corner.

The subject matter disclosed and claimed herein, in one embodiment thereof, comprises a rug corner pet-chewing prevention device. The device comprises a durable, flexible body made from materials like thermoplastic elastomer or silicone-based rubber, providing resilience and non-slip properties. The body is shaped to fit around various corners, such as rugs or furniture legs, enhancing its versatility. It may include pet deterrents like bitter flavors or scent-based repellents, integrated through a microencapsulation process for lasting effectiveness. The body also comprises textured interior surfaces and fasteners to ensure stability, while the bottom surface is equipped with non-slip features and optional fasteners like suction cups or adhesives to prevent movement on different floor types. The device is installed by enclosing the corner within the body and securing it to the floor with the fasteners.

In this manner, the rug corner pet-chewing prevention device of the present invention accomplishes all the foregoing objectives and provides a device for preventing a pet from chewing on a rug or carpet. More specifically, the device can prevent a pet from chewing on a rug corner. To do so, the device can be removably attached to a rug corner.

### SUMMARY

The following presents a simplified summary to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a rug corner pet-chewing prevention device. The device is comprised of a body preferably made from a durable plastic and/or rubber material. The body is preferably triangular in shape, specifically designed to fit around and securely cover the corner of a rug.

In one embodiment, the body is infused with at least one flavor that is displeasing to animals to discourage an animal from biting or chewing on the body and/or the rug corner. In alternative embodiments, the flavor may be replaced with a scent-based deterrent, such as citronella or eucalyptus, that repels animals through smell rather than taste, offering additional flexibility depending on the pet's behavior.

The body is comprised of at least one side wall, which is connected to at least one top wall and at least one bottom wall. The walls are configured to create an enclosure that fully covers the corner of a rug, effectively preventing a pet from accessing and chewing on the corner.

In one embodiment, the interior surface of the walls may be comprised of at least one raised and/or recessed texture designed to improve grip and further secure the rug corner within the body, preventing it from slipping out during use. This texturing could be achieved by adding ridges, grooves, or dimples along the interior surface, which enhance friction between the device and the rug. In a further embodiment, the interior surface of the walls may be comprised of at least one fastener to further secure the corner within the body.

In one embodiment, a bottom surface of the bottom wall is comprised of a non-slip material, such as, but not limited to, a non-slip rubber. The non-slip material ensures that once the device is installed on the rug, it will remain in place even under pressure or movement, reducing the risk of the rug shifting out of place. The bottom surface may also be comprised of at least one fastener, such as, but not limited to, an adhesive fastener, a suction cup fastener, or a magnetic fastener. An adhesive fastener could be a reusable gel-based adhesive that sticks securely to a floor surface without leaving residue. Alternatively, the suction cup fastener could be beneficial in environments with smooth flooring, such as linoleum or polished tiles, allowing the device to stay anchored in place. If the rug is placed over a metallic surface or a magnetic material is incorporated into the rug, a magnetic fastener could also be used to secure the device in place.

The present invention is also comprised of a method of using the device. First, a device is provided comprised of a body with a bottom wall, a bottom surface with a fastener, a side wall, and a top wall. Then, a corner of a rug can be inserted between the walls such that it is inside the body. In one embodiment, the corner can be secured to a fastener on an interior surface of the body. Next, the fastener can be secured to a floor surface.

Accordingly, the rug corner pet-chewing prevention device of the present invention is particularly advantageous as it provides a device for preventing a pet from chewing on a rug or carpet. More specifically, the device can prevent a pet from chewing on a rug corner. To do so, the device can be removably attached to a rug corner. In this manner, the rug corner pet-chewing prevention device provides a solution to stopping pets from chewing on rug corners.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one potential embodiment of a rug corner pet-chewing prevention device of the present invention in accordance with the disclosed architecture;

FIG. 2 illustrates a perspective view of one potential embodiment of a rug corner pet-chewing prevention device of the present invention while attached to a rug in accordance with the disclosed architecture; and FIG. 3 illustrates a flowchart of a method of using one potential embodiment of a rug corner pet-chewing prevention device of the present invention in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth to provide a thorough understanding thereof. It may be evident, however, that the innovation can be practiced without these specific details. In other instances, well-known structures and devices are shown in block diagram form to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for a device for preventing a pet from chewing on a rug or carpet. There also exists a long-felt need in the art for a rug corner pet-chewing prevention device that can prevent a pet from chewing on a rug corner. More specifically, there exists a long-felt need in the art for a rug corner pet-chewing prevention device that can prevent a pet from chewing on a rug corner by covering a rug corner.

The present invention, in one exemplary embodiment, is comprised of a rug corner pet-chewing prevention device. The device is comprised of a body, preferably made from durable plastic and/or rubber material. It is ideally triangular in shape, specifically designed to fit around and securely cover the corner of a rug.

In one embodiment, the body is infused with a flavor that is unpleasant to animals, discouraging them from biting or chewing on the body or the rug corner. Alternatively, the flavor can be replaced with a scent-based deterrent, such as citronella or eucalyptus, to repel animals by smell rather than taste, offering flexibility based on the pet's behavior.

The body includes at least one side wall, connected to a top wall and a bottom wall. These walls create an enclosure that fully covers the rug corner, effectively preventing pets from accessing and chewing on it.

In one version, the interior surface of the walls may feature raised or recessed textures to enhance grip, further securing the rug corner within the body and preventing it from slipping. This texture could include ridges, grooves, or dimples, adding friction between the device and the rug. Additionally, the interior surface may include at least one fastener to further hold the corner in place.

The bottom surface of the bottom wall is made of a non-slip material, such as rubber, ensuring the device remains in place even under pressure or movement, reducing the risk of the rug shifting. The bottom surface may also include a fastener, such as an adhesive, suction cup, or magnetic fastener. An adhesive fastener could be a reusable gel-based material that sticks securely to the floor without leaving residue. The suction cup fastener may be useful for smooth surfaces like linoleum or tiles, while a magnetic fastener could be employed if the rug is placed over a metallic surface or contains magnetic material.

The invention also includes a method of use. First, the device, comprising a body with a bottom wall, bottom surface, fastener, side wall, and top wall, is provided. Next, a rug corner is inserted between the walls, placing it inside the body. In some embodiments, the corner may be secured to a fastener on the interior surface. Finally, the fastener is secured to the floor.

Therefore, the rug corner pet-chewing prevention device offers a practical solution to prevent pets from chewing on rugs, particularly the corners, by being removably attached to the rug corner.

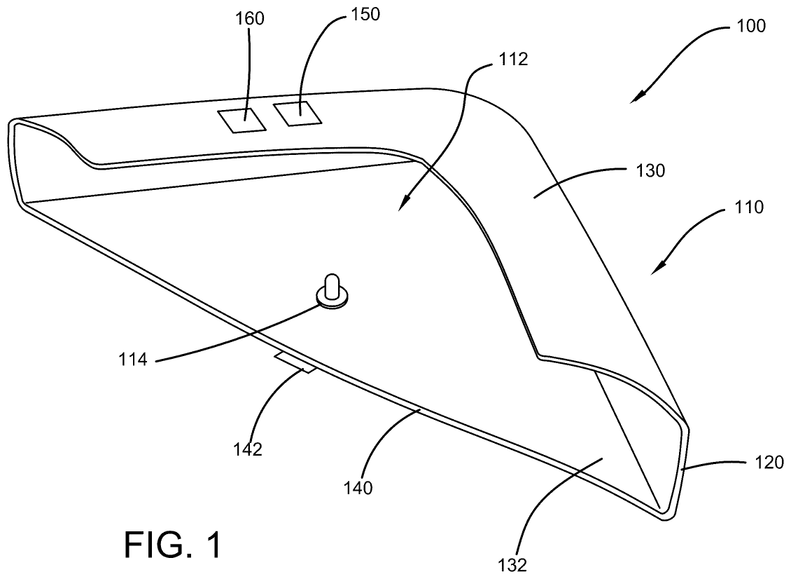

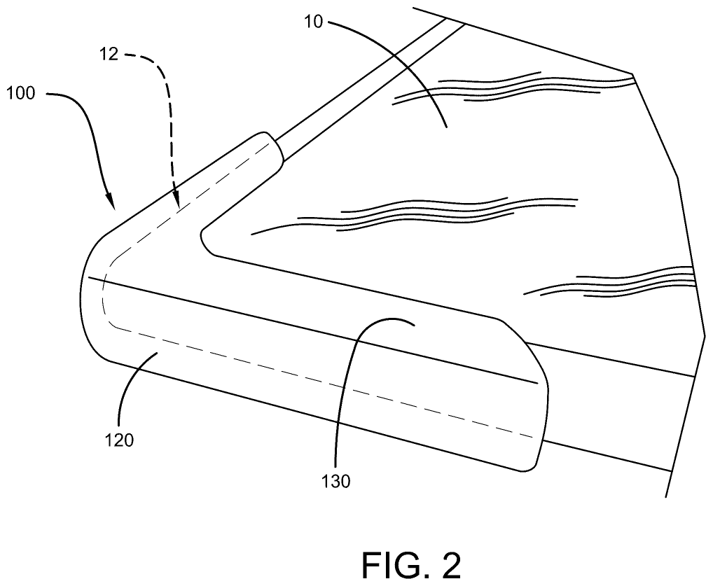

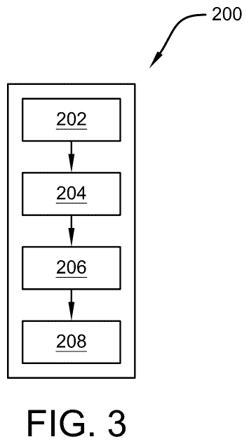

Referring initially to the drawings, FIG. 1 illustrates a perspective view of one potential embodiment of a rug corner pet-chewing prevention device 100 of the present invention in accordance with the disclosed architecture. The device 100 is comprised of a body 110. The body 110 is preferably made from a durable plastic and/or rubber material, which provides flexibility and resilience for long-term use under various environmental conditions. The plastic may be comprised of a thermoplastic elastomer (TPE) or polypropylene, which offers resistance to wear and tear. The rubber material may be comprised of a silicone-based compound that adds elasticity and non-slip properties. The body 110 is preferably triangular in shape, specifically designed to fit around and securely cover the corner 12 of a rug 10, as seen in FIG. 2. However, the shape of the body 110 can vary in different embodiments to accommodate various applications. For instance, it may be shaped to fit and/or cover any area of a piece of furniture, including, but not limited to, a corner of a couch, coffee table, desk, or chair leg. The ability to adapt the body 110 to different shapes enhances the versatility of the device 100, making it a multi-functional solution for preventing pet damage in multiple areas of a home.

In one embodiment, the body 110 is infused with at least one flavor 150 that is displeasing to animals to discourage an animal from biting or chewing on the body 110 and/or the rug 10 corner 12. The flavor 150 may be a bitter substance, such as, but not limited to, a bitter apple or citrus oil, known for being repellent to pets like dogs and cats. The flavor 150 can be implemented through a microencapsulation process, which allows the deterrent to be gradually released over time, ensuring long-lasting effectiveness. In alternative embodiments, the flavor 150 may be replaced with a scent-based deterrent 160, such as citronella or eucalyptus, that repels animals through smell rather than taste, offering additional flexibility depending on the pet's behavior.

The body 110 is comprised of at least one side wall 120, which is connected to at least one top wall 130 and at least one bottom wall 132. The walls 120, 130, 132 are configured to create an enclosure that fully covers the corner 12 of a rug 10, effectively preventing a pet from accessing and chewing on the corner. The side wall 120 may be angled or curved, depending on the specific embodiment, to provide a snug fit around different corner types. In some embodiments, the body 110 could include reinforced edges along the walls 120, 130, 132, enhancing the structural integrity of the device 100 and preventing it from deforming or becoming dislodged during use.

In one embodiment, the interior surface 112 of the walls 120, 130, 132 may be comprised of at least one raised and/or recessed texture designed to improve grip and further secure the rug 10 corner 12 within the body 110, preventing it from slipping out during use. This texturing could be achieved by adding ridges, grooves, or dimples along the interior surface 112, which enhance friction between the device 100 and the rug 10. In a further embodiment, the interior surface 112 of the walls 120, 130, 132 may be comprised of at least one fastener 114 to further secure the corner 12 within the body 110. The fastener 114 may include, but is not limited to, an adhesive fastener, such as double-sided tape; a hook fastener and/or a loop fastener; a mechanical fastener such as a clip, groove, pin, or tack; or a male-female fastener system. These fasteners provide additional stability, particularly for rugs or surfaces that are subject to high traffic or frequent movement.

In one embodiment, a bottom surface 140 of the bottom wall 132 is comprised of a non-slip material, such as, but not limited to, a non-slip rubber. The non-slip material ensures that once the device 100 is installed on the rug 10, it will remain in place even under pressure or movement, reducing the risk of the rug shifting out of place. The non-slip feature may be further enhanced through the use of a high-friction rubber compound, similar to materials used in anti-slip mats or shoe soles. In one embodiment, the bottom wall 132 is comprised of a raised and/or recessed texture, such as a grid or pattern of small bumps or ridges, which further increases traction and stability on hard surfaces like wood or tile floors. This textured design may also aid in minimizing movement of the rug 10 when the device 100 is attached.

The bottom surface 140 may also be comprised of at least one fastener 142, such as, but not limited to, an adhesive fastener, a suction cup fastener, or a magnetic fastener. An adhesive fastener could be a reusable gel-based adhesive that sticks securely to a floor surface without leaving residue. Alternatively, the suction cup fastener could be beneficial in environments with smooth flooring, such as linoleum or polished tiles, allowing the device 100 to stay anchored in place. If the rug 10 is placed over a metallic surface or a magnetic material is incorporated into the rug, a magnetic fastener could also be used to secure the device 100 in place.

The present invention is also comprised of a method of using 200 the device 100, as seen in FIG. 3. First, a device 100 is provided comprised of a body 110 comprised of a bottom wall 132 comprised of a bottom surface 140 comprised of a fastener 142, a side wall 120, and a top wall 130 [Step 202]. Then, a corner 12 of a rug 10 can be inserted between the walls 120, 130, 132 such that it is inside the body 110 [Step 204]. In one embodiment, the corner 12 can be secured to a fastener 114 on an interior surface 112 of the body 110 [Step 206]. Next, the fastener 142 can be secured to a floor surface [Step 208].

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “rug corner pet-chewing prevention device” and “device” are interchangeable and refer to the rug corner pet-chewing prevention device 100 of the present invention.

Notwithstanding the foregoing, the rug corner pet-chewing prevention device 100 of the present invention and its various components can be of any suitable size and configuration as is known in the art without affecting the overall concept of the invention, provided that they accomplish the above-stated objectives. One of ordinary skill in the art will appreciate that the size, configuration, and material of the rug corner pet-chewing prevention device 100 as shown in the FIGS. are for illustrative purposes only, and that many other sizes and shapes of the rug corner pet-chewing prevention device 100 are well within the scope of the present disclosure. Although the dimensions of the rug corner pet-chewing prevention device 100 are important design parameters for user convenience, the rug corner pet-chewing prevention device 100 may be of any size, shape, and/or configuration that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A rug corner pet-chewing prevention device comprising:
a body comprising a side wall, a top wall, and a bottom wall comprised of a non-slip surface;
wherein the body is configured to enclose a corner of a rug; and
wherein the bottom wall comprises a non-slip surface.

2. The rug corner pet-chewing prevention device of claim 1, wherein the body is comprised of a plastic material.

3. The rug corner pet-chewing prevention device of claim 1, wherein the body is comprised of a rubber material.

4. The rug corner pet-chewing prevention device of claim 1, wherein the body is comprised of a triangular shape.

5. The rug corner pet-chewing prevention device of claim 1, wherein the non-slip surface is comprised of a non-slip rubber.

6. The rug corner pet-chewing prevention device of claim 5, wherein the non-slip surface is comprised of a raised texture.

7. A rug corner pet-chewing prevention device comprising:
a body comprising a side wall, a top wall, and a bottom wall;
a first fastener disposed on an interior surface of the body for securing a corner of a rug within the body; and
a second fastener disposed on a bottom surface of the bottom wall.

8. The rug corner pet-chewing prevention device of claim 7, wherein the first fastener is comprised of an adhesive fastener, a hook fastener, a loop fastener, or a mechanical fastener.

9. The rug corner pet-chewing prevention device of claim 7, wherein the second fastener is comprised of an adhesive fastener, a suction cup fastener, or a magnetic fastener.

10. A rug corner pet-chewing prevention device comprising:
a triangular body comprising a side wall, a top wall, and a bottom wall, wherein the body is infused with a flavor or a scent;
a first fastener disposed on an interior surface of the body for securing a corner of a rug within the body; and
a second fastener disposed on a bottom surface of the bottom wall.

11. The rug corner pet-chewing prevention device of claim 10, wherein the flavor is comprised of a bitter apple.

12. The rug corner pet-chewing prevention device of claim 10, wherein the scent is comprised of a citronella or a eucalyptus.

13. The rug corner pet-chewing prevention device of claim 10, wherein an interior surface of the body is comprised of a texture.

14. The rug corner pet-chewing prevention device of claim 13, wherein the texture is comprised of a ridge, a groove, or a dimple.

15. The rug corner pet-chewing prevention device of claim 10, wherein the first fastener is comprised of an adhesive fastener, a hook fastener, a loop fastener, or a mechanical fastener.

16. The rug corner pet-chewing prevention device of claim 10, wherein the second fastener is comprised of an adhesive fastener, a suction cup fastener, or a magnetic fastener.

17. The rug corner pet-chewing prevention device of claim 10, wherein the body is comprised of a flexible material.

18. The rug corner pet-chewing prevention device of claim 17, wherein the body is comprised of a plastic material.

19. The rug corner pet-chewing prevention device of claim 17, wherein the body is comprised of a rubber material.

20. The rug corner pet-chewing prevention device of claim 10, wherein the bottom surface is comprised of a non-slip rubber.
